(19) United States
(12) Patent Application Publication
(10) Pub. No.: US 2025/0228349 A1
(43) Pub. Date: Jul. 17, 2025

(54) NAIL GRINDING MACHINE

(71) Applicant: Longwen XIAO, Shenzhen City (CN)

(72) Inventor: Longwen XIAO, Shenzhen City (CN)

(73) Assignee: Guangzhou Dachuang Nail Products Co., Ltd., Guangzhou (CN)

(21) Appl. No.: 19/056,688

(22) Filed: Feb. 18, 2025

(30) Foreign Application Priority Data
Jan. 9, 2025 (CN) 202510038891.8

(51) Int. Cl. A45D 29/05

(52) U.S. Cl. CPC A45D 29/05

(57) ABSTRACT

A nail grinding machine includes a handle, a drive motor, a spindle, an attitude detection device and a control device. The handle is provided with an accommodating chamber and an output opening communicating with the accommodating chamber. The drive motor is arranged within the accommodating chamber. The spindle is arranged at an output end of the drive motor and connected to the drive motor through a coupling, and an end of the spindle is positioned opposite to the output opening and is configured for connecting a grinding head. The attitude detection device is arranged within the handle, and the attitude detection device is configured to detect an attitude of the handle and output an attitude signal. The control device receives the attitude signal and controls the drive motor.

### CROSS-REFERENCE TO RELATED APPLICATIONS

The application claims priority of Chinese patent application CN2025100388918, filed on Jan. 9, 2025, which is incorporated herein by reference in its entirety.

### TECHNICAL FIELD

The present disclosure relates to the technical field of nail grinding machines, in particular to a nail grinding machine.

### BACKGROUND OF THE INVENTION

With the development of society, people have started to pursue beauty more. Manicure, as a way to decorate and beautify nails, has become increasingly popular among people, especially among young people who are extremely fond of manicures. During the manicure process, a nail grinding machine is required to grind nails for tasks such as trimming the shape of nails, grinding the nail surface, removing dead skin, and polishing and caring for nails.

When using a nail grinding machine, it is necessary to adjust the motor speed, rotation direction, etc. of the nail grinding machine according to usage requirements and the condition of the nails. Currently, for the nail grinding machines on the market, functions such as switching the rotation direction and starting/pausing are all achieved by pressing the buttons on the controller. Users need to frequently press the buttons on the controller to perform operations such as switching the motor rotation direction and starting/pausing, which results in low work efficiency. Moreover, it often happens that users forget to press the pause button after putting down the nail grinding machine, causing the grinding machine to keep working. This not only wastes electricity, reduces the product's battery life, affects the product's service life, but also poses a risk of accidents, threatening the safety of users.

Thus, the present invention provides a nail grinding machine, which can effectively solve the above problems. It has a simple structure and can conveniently achieve the function switching of the nail grinding machine by sensing the motion attitude, making it easy to use.

### SUMMARY OF THE INVENTION

In order to overcome the shortcomings of the prior art, the present invention provides a nail grinding machine. The nail grinding machine can conveniently achieve the function switching of the nail grinding machine by sensing the motion attitude, making it easy to use.

The technical solution adopted by the present invention to solve the technical problem is as follows.

A nail grinding machine includes a handle, a drive motor, a spindle, an attitude detection device and a control device. The handle is provided with an accommodating chamber and an output opening communicating with the accommodating chamber. The drive motor is arranged within the accommodating chamber. The spindle is arranged at an output end of the drive motor and connected to the drive motor through a coupling, and an end of the spindle is positioned opposite to the output opening and is configured for connecting a grinding head. The attitude detection device is arranged within the handle, and the attitude detection device is configured to detect an attitude of the handle and output an attitude signal. The control device receives the attitude signal and controls the drive motor.

As an improvement of the present invention, when the attitude detection device detects that the handle is in a switching attitude, the control device controls the drive motor to reverse based on the attitude signal; when the attitude detection device detects that the handle is in a stationary attitude, the control device controls the drive motor to turn off based on the attitude signal.

As an improvement of the present invention, the attitude detection device includes a gyroscope module and a data processing module, and the gyroscope module is coupled to the data processing module; the gyroscope module is configured to detect an included angle α between the handle and a vertical axis, and the data processing module is configured to calculate an angular velocity w of the handle based on a change in the included angle α and a corresponding time; when the included angle a between the handle and the vertical axis is within a first preset included angle range and the angular velocity ω of the handle is greater than a preset angular velocity ω0, and when the handle is in the switching attitude, the control device controls the drive motor to reverse based on the attitude signal.

As an improvement of the present invention, when the included angle α between the handle and the vertical axis is within a second preset included angle range, the data processing module calculates a time t during which the included angle a falls within the second preset included angle range, and when the time t exceeds a preset time t0 and the handle is in the stationary attitude, the control device controls the drive motor to turn off based on the attitude signal.

As an improvement of the present invention, the attitude detection device further includes an LDO buck module, the LDO buck module is configured to be coupled to a power output end, and the gyroscope module and the data processing module are coupled to the LDO buck module.

As an improvement of the present invention, a SDA pin of the gyroscope module is coupled to a SDA pin of the data processing module, and a SCL pin of the gyroscope module is coupled to a SCL pin of the data processing module.

As an improvement of the present invention, a VIN pin of the LDO buck module is configured to be coupled to the power output end, and the SDA pin of the gyroscope module, the SDA pin of the data processing module and a RES pin of the data processing module are coupled to a VOUT pin of the LDO buck module.

As an improvement of the present invention, the control device is a control chip, and a SENSER IN pin of the data processing module is coupled to a SENSER IN pin of the control chip.

As an improvement of the present invention, the nail grinding machine further includes a cable and a cable plug, and the cable plug is connected to an end of the cable and is inserted into an end of the handle; an accommodation space is provided within the cable plug, the attitude detection device is arranged within the accommodation space, and a shock-absorbing silicone sleeve is wrapped around an outside of the attitude detection device.

As an improvement of the present invention, the handle includes a gripping shell, a motor shell and an end cap; the gripping shell is connected to one end of the motor shell, and the end cap is connected to the other end of the motor shell; the spindle is arranged within the gripping shell, and the drive motor is arranged within the motor shell; the end cap is provided with a through hole, and the cable plug is inserted into the end cap while the cable passes through the through hole and extends outwards.

As an improvement of the present invention, the cable plug includes a bracket and electrical connection pins. The electrical connection pins are connected to the bracket and electrically connected to the cable, and the free end of the electrical connection pins is electrically connected to the drive motor. At the end of the cable, injection molding and encapsulation are carried out on the outer surface of the shock-absorbing silicone sleeve and the outer surface of the bracket, forming a cable plug shell.

As an improvement of the present invention, a clamping groove is provided on the bracket, and a clamping block is provided on the outer surface of the shock-absorbing silicone sleeve. The clamping block is clamped into the clamping groove.

As an improvement of the present invention, an insertion slot is provided within the shock-absorbing silicone sleeve. The edge of the attitude detection device is inserted into the insertion slot, and the shape of the attitude detection device matches the shape of the insertion slot.

As an improvement of the present invention, three first threaded connection parts are arranged at the two ends of the drive motor. The gripping shell, the motor shell, and the end cap are all provided with second threaded connection parts, and the second threaded connection parts are threadedly connected to the first threaded connection parts.

As an improvement of the present invention, two bearings are also provided within the gripping shell, and the bearings are arranged around the spindle.

The present invention has the following beneficial effects. Through the arrangement of the above structure, during use, the drive motor drives the spindle 300, which in turn drives the grinding head to rotate, thereby grinding the user's nails. When it is necessary to adjust the working state of the nail grinding machine, the nail grinding machine can be adjusted to a specific posture or its posture can be changed. The attitude detection device detects the specific posture and its changes, and outputs the corresponding attitude signal. The control device then receives the attitude signal and controls the drive motor to change its working state according to the type of the attitude signal. For example, when it is necessary to power off the nail grinding machine, it can be placed horizontally on a working surface such as a desktop or vertically on a bracket. At this moment, the attitude detection device outputs the corresponding attitude signal, and the control device controls the drive motor to turn it off. Another example is that when it is necessary to change the rotation direction or speed of the drive motor, the nail grinding machine can be quickly shaken or turned upside down. At this time, the attitude detection device outputs the corresponding attitude signal, and the control device controls the drive motor to make it rotate in the reverse direction.

### BRIEF DESCRIPTION OF DRAWINGS

In order to explain the technical solutions of the embodiments of the present invention more clearly, the following will briefly introduce the accompanying drawings used in the embodiments. The drawings in the following description are only some embodiments of the present invention. Those of ordinary skill in the art can obtain other drawings based on these drawings without creative work.

The present invention is further described below in detail in combination with the accompanying drawings and embodiments.

FIG. 1 is a schematic diagram of an overall circuit module of the nail grinding machine according to the present invention;

FIG. 2 is a schematic diagram of a circuit module of an attitude detection device of the nail grinding machine according to the present invention;

FIG. 3 is a schematic diagram from an angle of an entire structure of the nail grinding machine according to the present invention;

FIG. 4 is a schematic diagram from another angle of the entire structure of the nail grinding machine according to the present invention;

FIG. 5 is a schematic diagram from an angle of an exploded structure of the nail grinding machine according to the present invention;

FIG. 6 is a schematic diagram from another angle of the exploded structure of the nail grinding machine according to the present invention;

FIG. 7 is a schematic diagram of a first partial exploded structure of the nail grinding machine according to the present invention;

FIG. 8 is a schematic diagram of a second partial exploded structure of the nail grinding machine according to the present invention;

FIG. 9 is a schematic diagram of a sectional structure of the nail grinding machine according to the present invention;

FIG. 10 is an enlarged view of an area circled A in FIG. 9;

FIG. 11 is a circuit diagram of a gyroscope module according to the present invention;

FIG. 12 is a circuit diagram of a data processing module according to the present invention;

FIG. 13 is a circuit diagram of an LDO buck module according to the present invention; and

FIG. 14 is a circuit diagram of a control device according to the present invention.

### DETAILED DESCRIPTION OF THE INVENTION

To make the aforementioned objectives, features, and advantages of the present invention more comprehensible, specific implementations of the present invention are described in detail below in conjunction with the accompanying drawings. In the following description, numerous specific details are set forth to provide a thorough understanding of the present invention. The present invention may, however, be embodied in many forms different from that described here. A person skilled in the art can make similar improvements without departing from the connotation of the present invention. Therefore, the present invention is not limited by the specific embodiments disclosed below.

In the description of the present invention, It is to be understood that, The terms “center”, “longitudinal”, “transverse”, “upper”, “lower”, “front”, “rear”, “left”, “right”, “vertical”, “horizontal”, “top”, “bottom”, “inner”, “outer”, “clockwise”, “counterclockwise”, and the like indicate azimuth or positional relationships based on the azimuth or positional relationships shown in the drawings, For purposes of convenience only of describing the present invention and simplifying the description, Rather than indicating or implying that the indicated device or element must have a particular orientation, be constructed and operated in a particular orientation, therefore, not to be construed as limiting the present invention.

In addition, the terms “first” and “second” are used for descriptive purposes only, while not to be construed as indicating or implying relative importance or implicitly specifying the number of technical features indicated thereby, features defining “first,” “second,” and “second” may explicitly or implicitly include one or more of the described features. In the description of the present invention, “multiple” means two or more unless explicitly specified otherwise.

In addition, the terms “install”, “arrange”, “provide”, “connect” and “couple” should be understood broadly. For example, it can be a fixed connection, a detachable connection, an integral structure, a mechanical connection, an electrical connection, a direct connection, an indirect connection through an intermediate medium, or a communication between two devices, elements or components. For ordinary technical personnel in this field, the specific meanings of the above terms in present invention can be understood based on specific circumstances.

In the present invention, unless specific regulation and limitation otherwise, the first feature “onto” or “under” the second feature may include the direct contact of the first feature and the second feature, or may include the contact of the first feature and the second feature through other features between them instead of direct contact. Moreover, the first feature “onto”, “above” and “on” the second feature includes that the first feature is right above and obliquely above the second feature, or merely indicates that the horizontal height of the first feature is higher than the second feature. The first feature “under”, “below” and “down” the second feature includes that the first feature is right above and obliquely above the second feature, or merely indicates that the horizontal height of the first feature is less than the second feature.

It should be noted that when an element is referred to as being “fixed to” another element, the element can be directly on another component or there can be a centered element. When an element is considered to be “connected” to another element, the element can be directly connected to another element or there may be a centered element. The terms “inner”, “outer”, “left”, “right”, and similar expressions used herein are for illustrative purposes only and do not necessarily represent the only implementation.

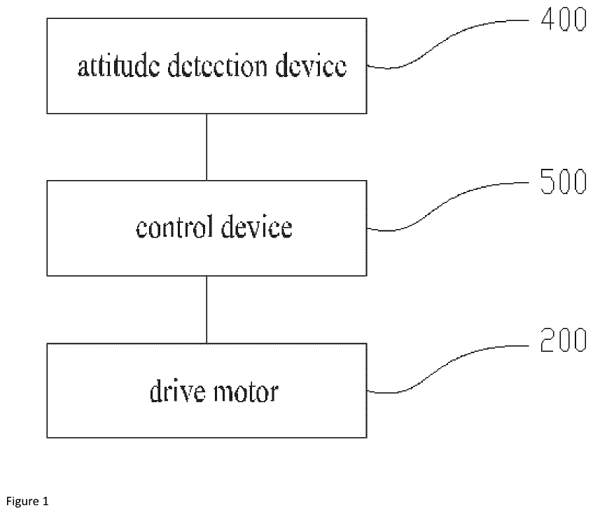

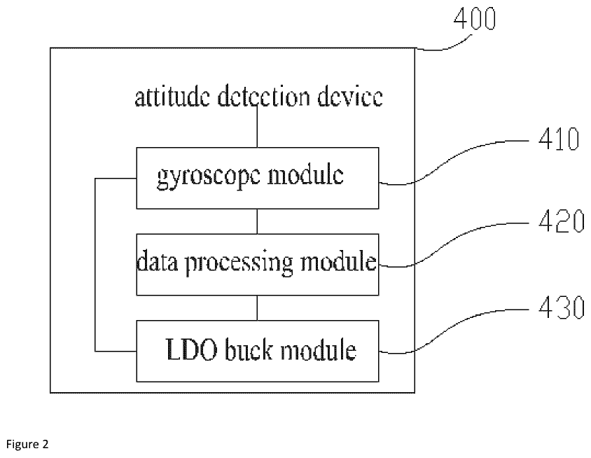

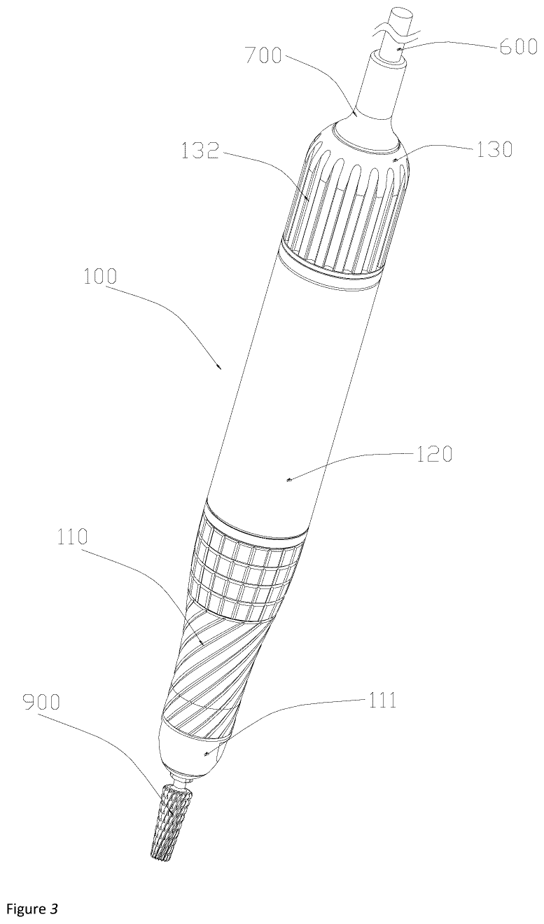

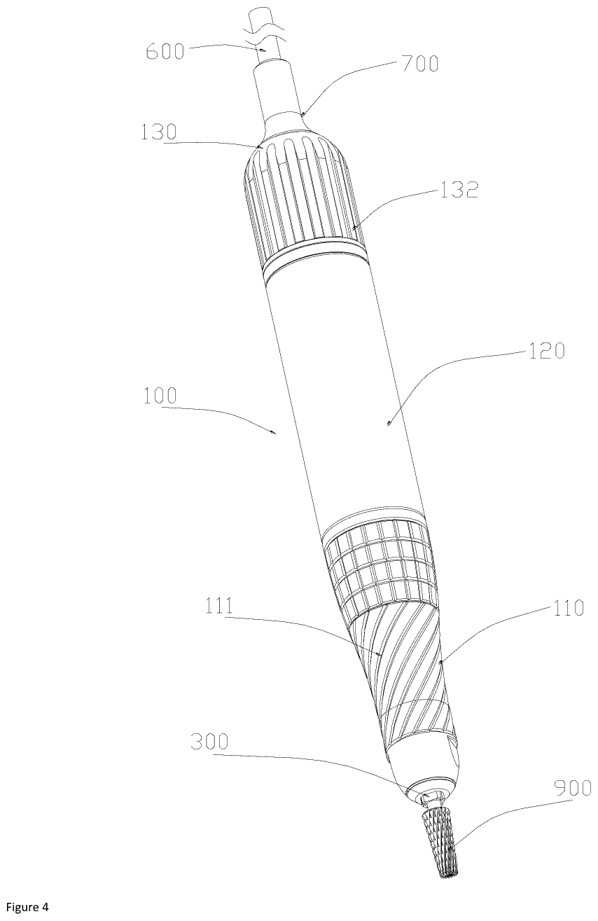

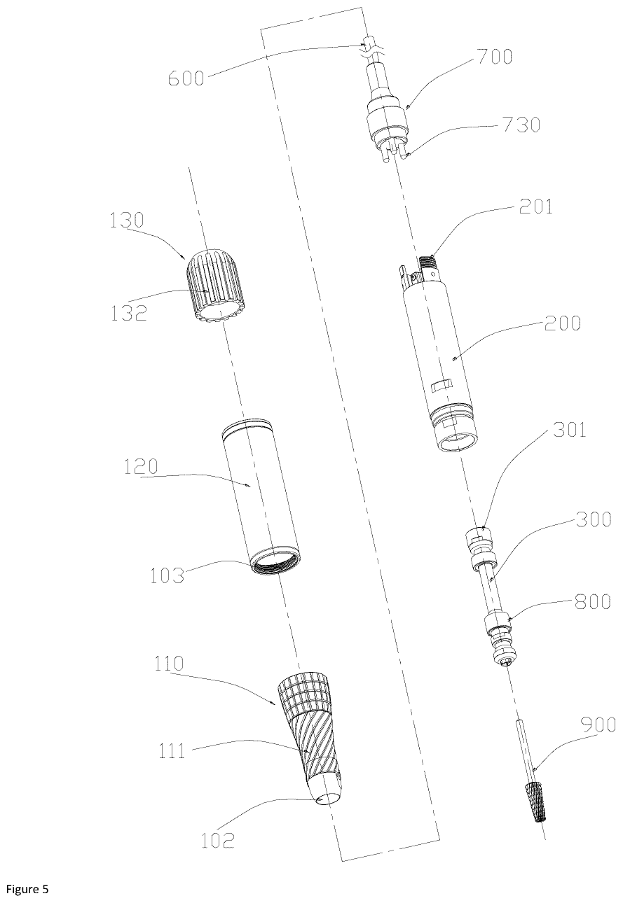

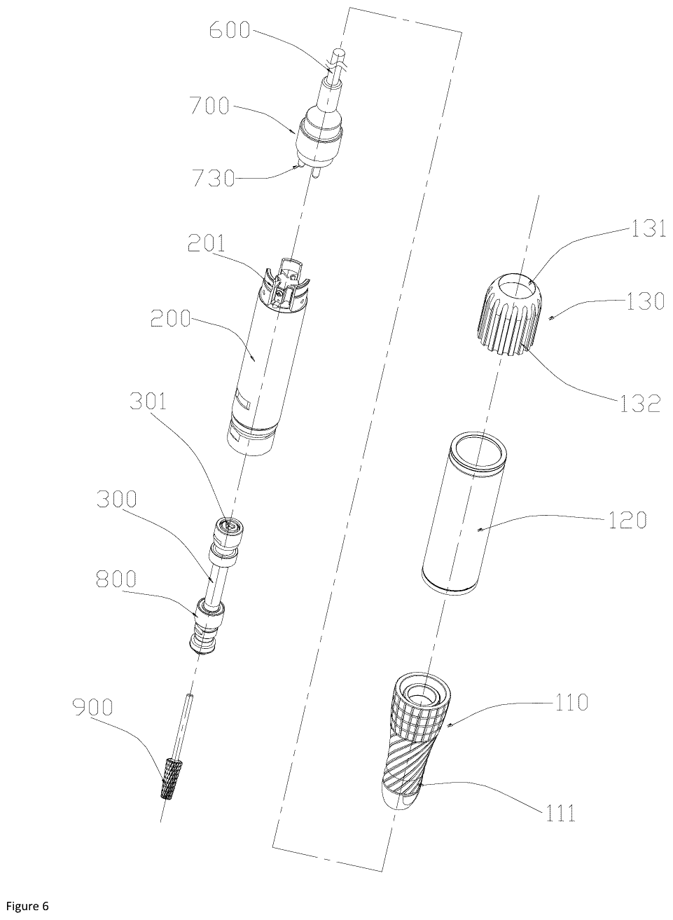

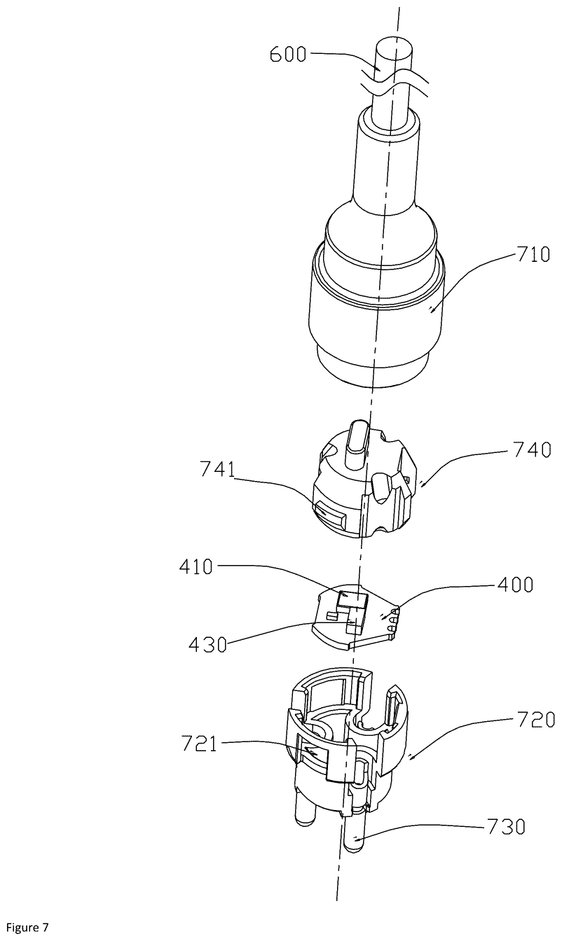

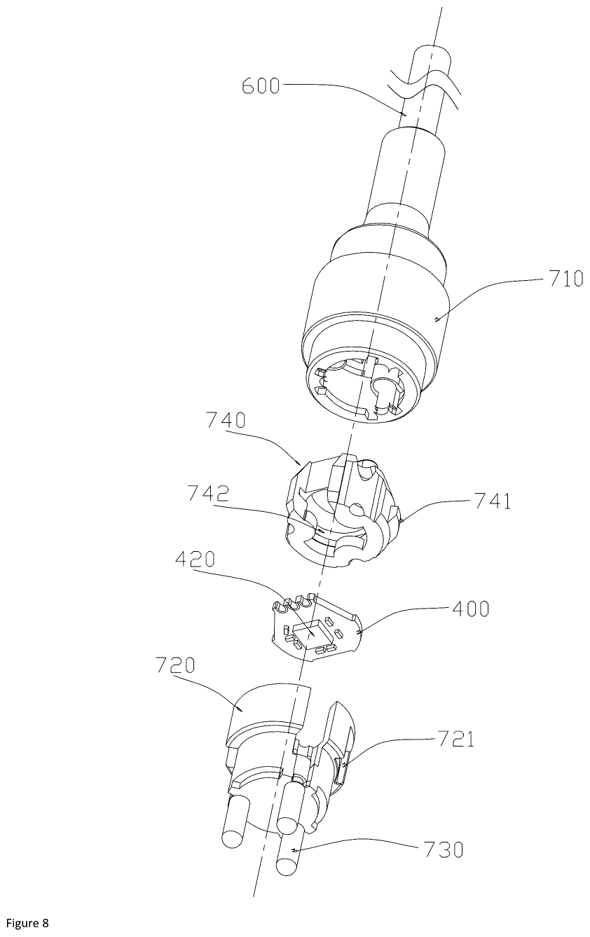

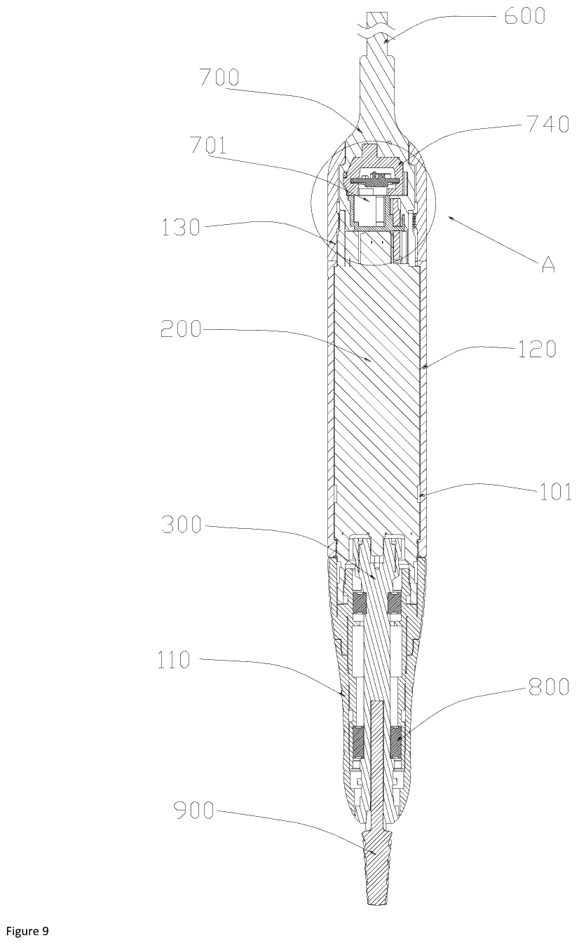

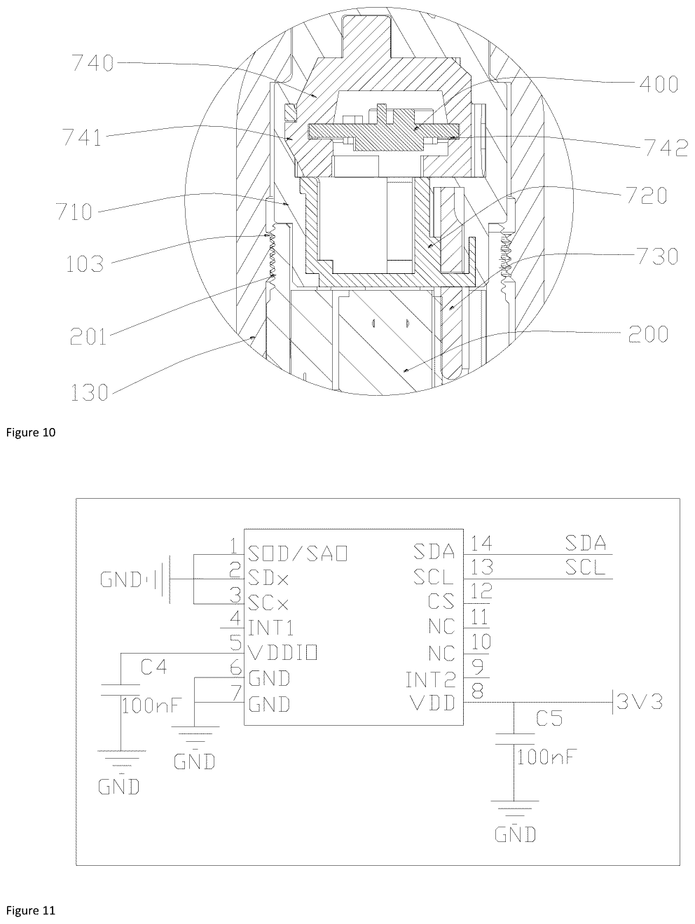

Referring to FIG. 1 to FIG. 14, a nail grinding machine includes a handle 100, a drive motor 200, a spindle 300, an attitude detection device 400 and a control device 500. The handle 100 is provided with an accommodating chamber 101 and an output opening 102 communicating with the accommodating chamber 101. The drive motor 200 is arranged within the accommodating chamber. The spindle 300 is arranged at an output end of the drive motor 200 and connected to the drive motor 200 through a coupling 301, and an end of the spindle 300 is positioned opposite to the output opening 102 and is configured for connecting a grinding head 900. The attitude detection device 400 is arranged within the handle 100, and the attitude detection device 400 is configured to detect an attitude of the handle 100 and output an attitude signal. The control device 500 receives the attitude signal and controls the drive motor 200.

Through the arrangement of the above structure, during use, the drive motor 200 drives the spindle 300, which in turn drives the grinding head to rotate, thereby grinding the user's nails. When it is necessary to adjust the working state of the nail grinding machine, the nail grinding machine can be adjusted to a specific posture or its posture can be changed. The attitude detection device 400 detects the specific posture and its changes, and outputs the corresponding attitude signal. The control device 500 then receives the attitude signal and controls the drive motor 200 to change its working state according to the type of the attitude signal. For example, when it is necessary to power off the nail grinding machine, it can be placed horizontally on a working surface such as a desktop or vertically on a bracket. At this moment, the attitude detection device 400 outputs the corresponding attitude signal, and the control device 500 controls the drive motor 200 to turn it off. Another example is that when it is necessary to change the rotation direction or speed of the drive motor 200, the nail grinding machine can be quickly shaken or turned upside down. At this time, the attitude detection device 400 outputs the corresponding attitude signal, and the control device 500 controls the drive motor 200 to make it rotate in the reverse direction.

In this embodiment, when the attitude detection device 400 detects that the handle 100 is in a switching attitude, the control device 500 controls the drive motor 200 to reverse based on the attitude signal; when the attitude detection device 400 detects that the handle 100 is in a stationary attitude, the control device 500 controls the drive motor 200 to turn off based on the attitude signal.

In this embodiment, the attitude detection device 400 includes a gyroscope module 410 and a data processing module 420, and the gyroscope module 410 is coupled to the data processing module 420. The gyroscope module 410 is configured to detect an included angle α between the handle 100 and a vertical axis, and the data processing module 420 is configured to calculate an angular velocity ω of the handle 100 based on a change in the included angle α and a corresponding time. When the included angle α between the handle 100 and the vertical axis is within a first preset included angle range and the angular velocity ω of the handle 100 is greater than a preset angular velocity ω0, and when the handle 100 is in the switching attitude, the control device 500 controls the drive motor 200 to reverse based on the attitude signal. Through the arrangement of the above structure, when the user needs to switch the rotation direction of the grinding head of the nail grinding machine, the handle 100 can be adjusted to make it in a vertical or horizontal state, and then the handle 100 is quickly shaken. At this time, the gyroscope module 410 detects that the included angle α between the handle 100 and the vertical axis is within the first preset angle range, and also detects that the angular velocity ω of the handle 100 is greater than the preset angular velocity ω0. The data processing module 420 judges that the handle 100 is in the switching attitude based on the above data and outputs the corresponding attitude signal, and the control device 500 controls the drive motor 200 to reverse. Preferably, since the nail grinding machine is usually tilted during normal use and will not be in a nearly vertical state, the first preset angle range is set at 0-5 degrees. At this time, the handle 100 is approximately in a vertical state, which is significantly different from the state of the nail grinding machine during normal use, so misjudgment can be effectively avoided. Then, when the shaking is detected, that is, when it is detected that the angular velocity ω of the handle 100 is greater than the preset angular velocity ω0, misjudgment caused by the user accidentally holding the product upright can be effectively avoided, making it more convenient for the user and the product more reliable. Preferably, the first preset angle range can also be set at 85-90 degrees. At this time, the nail grinding machine product is approximately in a horizontal state, and this state is also significantly different from the state during normal use, and it is not easy to cause misjudgment.

In this embodiment, when the included angle a between the handle 100 and the vertical axis is within a second preset included angle range, the data processing module 420 calculates a time t during which the included angle a falls within the second preset included angle range. When the time t exceeds a preset time t0 and the handle 100 is in the stationary attitude, the control device 500 controls the drive motor 200 to turn off based on the attitude signal. Through the arrangement of the above structure, during use, when the nail grinding machine is placed on an operating surface such as a desktop, the nail grinding machine is approximately in a horizontal state. The gyroscope module 410 detects that the included angle α between it and the vertical axis is approximately 90 degrees. The data processing module 420 calculates whether the time t when the nail grinding machine is in the flat state exceeds the preset time t0. If the time t when the nail grinding machine is in the flat state exceeds the preset time t0, the data processing module 420 outputs the corresponding attitude signal, and the control device 500 controls the drive motor 200 to turn off. On one hand, this can effectively prevent accidents, and on the other hand, it can also reduce energy consumption and improve the product's battery life. For example, when the nail grinding machine is placed flat on the desktop for more than 5 seconds and no motion signal is detected, the motor drive output is paused.

In this embodiment, the attitude detection device 400 also includes an LDO buck module 430, the LDO buck module 430 is configured to be coupled to a power output end, and the gyroscope module 410 and the data processing module 420 are coupled to the LDO buck module 430. Through the arrangement of the above structure, during use, the LDO buck module 430 is coupled to the power output end and can perform voltage reduction and voltage stabilization to provide a stable power supply for the gyroscope module 410 and the data processing module 420, effectively ensuring the safety and stability of the circuit.

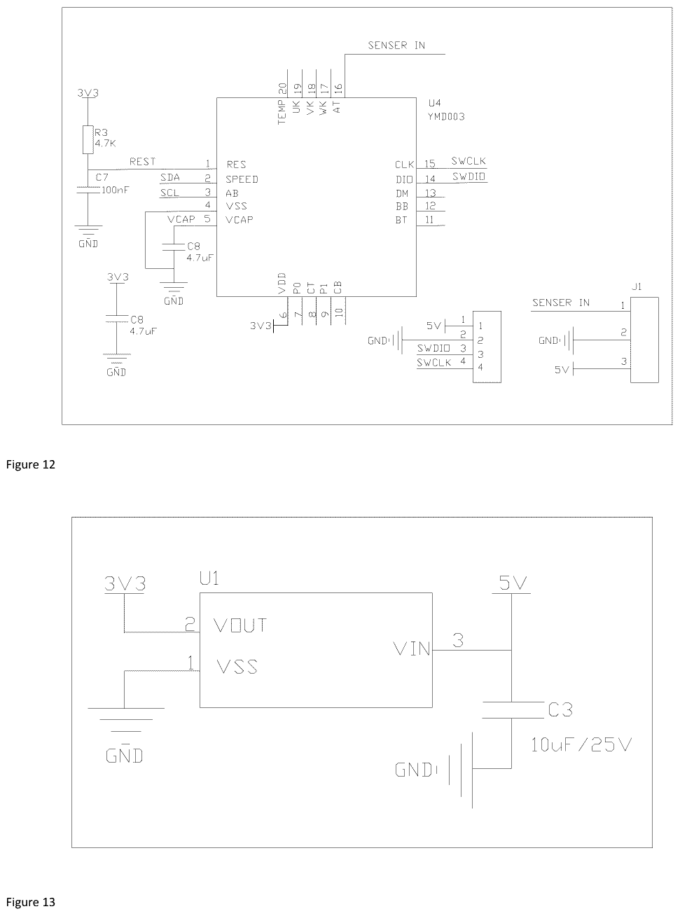

In this embodiment, a SDA pin of the gyroscope module 410 is coupled to a SDA pin of the data processing module 420, and a SCL pin of the gyroscope module 410 is coupled to a SCL pin of the data processing module 420. Through the arrangement of the above structure, referring to FIG. 11 to FIG. 12, the SDA pin of the gyroscope module 410 is coupled to the SDA pin of the data processing module 420, and the SCL pin of the gyroscope module 410 is coupled to the SCL pin of the data processing module 420, which enables signal transmission between the gyroscope module 410 and the data processing module 420, so that the data processing module 420 can receive signals from the gyroscope module 410 and perform corresponding processing.

In this embodiment, a VIN pin of the LDO buck module 430 is configured to be coupled to the power output end, and the SDA pin of the gyroscope module 410, the SDA pin of the data processing module 420 and a RES pin of the data processing module 420 are coupled to a VOUT pin of the LDO buck module 430. Through the arrangement of the above structure, the VIN pin of the LDO buck module 430 is coupled to the power output end, and the SDA pin of the gyroscope module 410, the SDA pin of the data processing module 420, and the RES pin of the data processing module 420 are coupled to the VOUT pin of the LDO buck module 430, which can provide a stable and appropriate voltage for the gyroscope module 410 and the data processing module 420. Referring to FIG. 11 to FIG. 13, the VIN pin of the LDO buck module 430 is connected to a 5V DC input voltage, while the VOUT pin of the LDO buck module 430 outputs a 3.3V voltage.

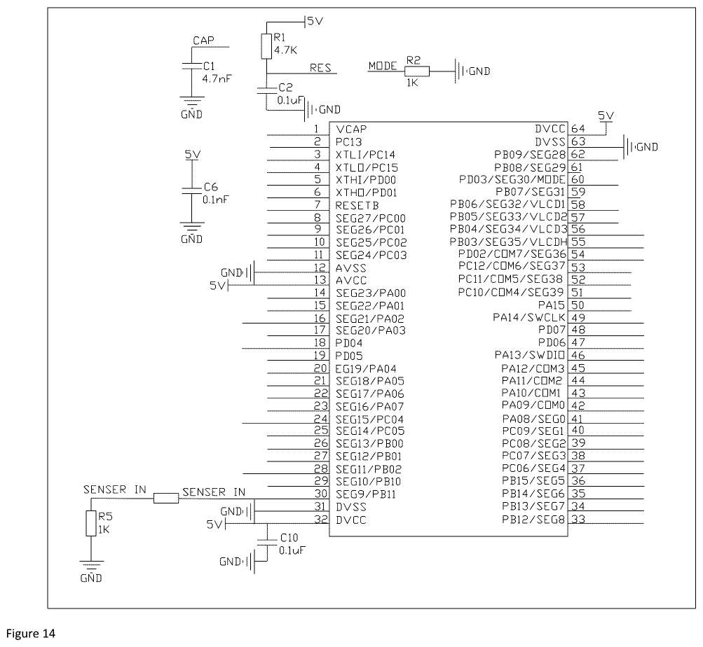

In this embodiment, the control device 500 is a control chip, and a SENSER IN pin of the data processing module 420 is coupled to a SENSER IN pin of the control chip. Through the arrangement of the above structure, referring to FIG. 12 and FIG. 14, the SENSER IN pin of the data processing module 420 is coupled to the SENSER IN pin of the control chip. The signal can be transmitted to the control chip through multiple SENSER IN pins and communication interfaces, and the control chip controls the drive motor based on the signal to change its working state, such as control the drive motor to reverse, change the rotation speed of the drive motor, and turn off the drive motor, effectively ensuring the stability of signal output.

In this embodiment, the nail grinding machine also includes a cable 600 and a cable plug 700, and the cable plug 700 is connected to an end of the cable 600 and is inserted into an end of the handle 100. An accommodation space 701 is provided within the cable plug 700, the attitude detection device 400 is arranged within the accommodation space 701, and a shock-absorbing silicone sleeve 740 is wrapped around an outside of the attitude detection device 400. Through the arrangement of the above structure, the cable plug 700 is connected to the end of the cable 600 and inserted into the end of the handle 100, which enables the connection of the cable 600, the cable plug 700 and the handle 100. Moreover, the attitude detection device 400 is arranged within the accommodation space 701, which can effectively protect the attitude detection device 400, prevent the attitude detection device 400 from being damaged, and ensure the stability of the product. Additionally, the shock-absorbing silicone sleeve 740 is wrapped around the outside of the attitude detection device 400, and the shock-absorbing silicone sleeve 740 can effectively reduce the influence of motor vibration on the gyroscope signal, reduce misjudgment, and improve the stability of the product.

In this embodiment, the handle 100 includes a gripping shell 110, a motor shell 120 and an end cap 130. The gripping shell 110 is connected to one end of the motor shell 120, and the end cap 130 is connected to the other end of the motor shell 120. The spindle 300 is arranged within the gripping shell 110, and the drive motor 200 is arranged within the motor shell 120. The end cap 130 is provided with a through hole 131, and the cable plug 700 is inserted into the end cap 130 while the cable 600 passes through the through hole 131 and extends outwards. Through the arrangement of the above structure, the gripping shell 110, the motor shell 120, and the end cap 130 are connected in sequence to form a pen-shaped handle 100. The spindle 300 is inserted into the gripping shell 110, and the gripping shell 110 can effectively protect the spindle 300. Preferably, the surface of the gripping shell 110 is provided with friction patterns 111, which can increase the friction force, enabling users to hold the gripping shell 110 more stably and facilitating user operation. The motor shell 120 can provide protection for the drive motor 200 to prevent the drive motor 200 from being damaged. Preferably, the motor shell 120 is a flexible hose. During installation, the cable 600 passes through the through hole 131 and extends outwards until the cable plug 700 is inserted into the end cap 130, and then the end cap 130 is connected, so that the cable plug 700 can be stably and conveniently fixed, thereby achieving the electrical connection between the drive motor 200 and the cable plug 700. Preferably, the end cap 130 is provided with vertical friction stripes 132 to increase the friction coefficient on the surface of the end cap 130, facilitating users to screw the end cap 130 and making the product installation more convenient and labor-saving.

In this embodiment, the cable plug 700 includes a bracket 720 and electrical connection pins 730. The electrical connection pins 730 are connected to the bracket 720 and electrically connected to the cable 600, and the free end of the electrical connection pins 730 is electrically connected to the drive motor 200. At the end of the cable 600, injection molding and encapsulation are carried out on the outer surface of the shock-absorbing silicone sleeve 740 and the outer surface of the bracket 720, forming a cable plug shell 710. Through the arrangement of the above structure, during the production of the product, the electrical connection pins 730 are connected to the bracket 720 and electrically connected to the cable 600, and then the cable plug shell 710 is formed by injection molding and encapsulation on the outer surface of the shock-absorbing silicone sleeve 740, the outer surface of the bracket 720, and at the end of the cable 600. The cable plug shell 710 can effectively provide protection for the shock-absorbing silicone sleeve 740, the bracket 720, and part of the electrical connection pins 730 within it, and can cover the electrical connections to ensure the stability of the electrical connection. During the assembly of the product, the free end of the electrical connection pins 730 is electrically connected to the drive motor 200, thereby enabling the electrical connection between the drive motor 200 and the external power supply and providing a stable power supply for the drive motor 200.

In this embodiment, a clamping groove 721 is provided on the bracket 720, and a clamping block 741 is provided on the outer surface of the shock-absorbing silicone sleeve 740. The clamping block 741 is clamped into the clamping groove 721. Through the arrangement of the above structure, during the assembly of the product, by clamping the clamping block 741 into the clamping groove 721, the shock-absorbing silicone sleeve 740 can be first connected to the bracket 720, and then the attitude detection device 400 inside the shock-absorbing silicone sleeve 740 can be fixed. Subsequently, injection molding is carried out at the end of the cable 600, on the shock-absorbing silicone sleeve 740, and on the bracket 720 to form a cable plug shell 710, thus assembling a stable cable plug 700. The assembly is convenient and quick, and the product structure is stable.

In this embodiment, an insertion slot 742 is provided within the shock-absorbing silicone sleeve 740. The edge of the attitude detection device 400 is inserted into the insertion slot 742, and the shape of the attitude detection device 400 matches the shape of the insertion slot 742. Through the arrangement of the above structure, during the assembly of the product, by inserting the attitude detection device 400 into the insertion slot 742, the attitude detection device 400 can be effectively fixed, preventing the attitude detection device 400 from shifting during product use, and ensuring that the attitude detection device 400 can accurately detect the state of the nail grinding machine. Furthermore, this allows users to adjust the working state of the drive motor 200 by changing the attitude of the nail grinding machine, making it more convenient for users.

In this embodiment, three first threaded connection parts 201 are arranged at the two ends of the drive motor 200. The gripping shell 110, the motor shell 120, and the end cap 130 are all provided with second threaded connection parts 103, and the second threaded connection parts 103 are threadedly connected to the first threaded connection parts 201. Through the arrangement of the above structure, during the assembly of the product, the second threaded connection parts 103 of the gripping shell 110, the motor shell 120, and the end cap 130 are respectively connected to the three first threaded connection parts 201 at the ends of the drive motor 200, thereby realizing the connection of the gripping shell 110, the motor shell 120, and the end cap 130 to form a pen-shaped handle 100, and the product assembly efficiency is high.

In this embodiment, two bearings 800 are also provided within the gripping shell 110, and the bearings 800 are arranged around the spindle 300. Through the arrangement of the above structure, by providing two bearings 800 at the front and rear ends of the spindle 300, the spindle 300 can be fixed in the radial direction, enabling the spindle 300 to rotate stably around the rotation axis, and the product structure is more stable.

1. A nail grinding machine, comprising
a handle, wherein the handle is provided with an accommodating chamber and an output opening communicating with the accommodating chamber;
a drive motor, wherein the drive motor is arranged within the accommodating chamber;
a spindle, wherein the spindle is arranged at an output end of the drive motor and connected to the drive motor through a coupling, and an end of the spindle is positioned opposite to the output opening and is configured for connecting a grinding head;
an attitude detection device, wherein the attitude detection device is arranged within the handle, and the attitude detection device is configured to detect an attitude of the handle and output an attitude signal;
a control device, wherein the control device receives the attitude signal and controls the drive motor.

2. The nail grinding machine according to claim 1, wherein when the attitude detection device detects that the handle is in a switching attitude, the control device controls the drive motor to reverse based on the attitude signal; when the attitude detection device detects that the handle is in a stationary attitude, the control device controls the drive motor to turn off based on the attitude signal.

3. The nail grinding machine according to claim 2, wherein the attitude detection device comprises a gyroscope module and a data processing module, and the gyroscope module is coupled to the data processing module; the gyroscope module is configured to detect an included angle α between the handle and a vertical axis, and the data processing module is configured to calculate an angular velocity ω of the handle based on a change in the included angle α and a corresponding time; when the included angle a between the handle and the vertical axis is within a first preset included angle range and the angular velocity ω of the handle is greater than a preset angular velocity ω0, and when the handle is in the switching attitude, the control device controls the drive motor to reverse based on the attitude signal.

4. The nail grinding machine according to claim 3, wherein when the included angle α between the handle and the vertical axis is within a second preset included angle range, the data processing module calculates a time t during which the included angle α falls within the second preset included angle range, and when the time t exceeds a preset time t0 and the handle is in the stationary attitude, the control device controls the drive motor to turn off based on the attitude signal.

5. The nail grinding machine according to claim 3, wherein the attitude detection device further comprises an LDO buck module, the LDO buck module is configured to be coupled to a power output end, and the gyroscope module and the data processing module are coupled to the LDO buck module.

6. The nail grinding machine according to claim 3, wherein a SDA pin of the gyroscope module is coupled to a SDA pin of the data processing module, and a SCL pin of the gyroscope module is coupled to a SCL pin of the data processing module.

7. The nail grinding machine according to claim 5, wherein a VIN pin of the LDO buck module is configured to be coupled to the power output end, and the SDA pin of the gyroscope module, the SDA pin of the data processing module and a RES pin of the data processing module are coupled to a VOUT pin of the LDO buck module.

8. The nail grinding machine according to claim 3, wherein the control device is a control chip, and a SENSER IN pin of the data processing module is coupled to a SENSER IN pin of the control chip.

9. The nail grinding machine according to claim 1, wherein the nail grinding machine further comprises a cable and a cable plug, and the cable plug is connected to an end of the cable and is inserted into an end of the handle; an accommodation space is provided within the cable plug, the attitude detection device is arranged within the accommodation space, and a shock-absorbing silicone sleeve is wrapped around an outside of the attitude detection device.

10. The nail grinding machine according to claim 9, wherein the handle comprises a gripping shell, a motor shell and an end cap; the gripping shell is connected to one end of the motor shell, and the end cap is connected to the other end of the motor shell; the spindle is arranged within the gripping shell, and the drive motor is arranged within the motor shell; the end cap is provided with a through hole, and the cable plug is inserted into the end cap while the cable passes through the through hole and extends outwards.
